(19) United States
(12) Patent Application Publication
(10) Pub. No.: US 2018/0329612 A1
(43) Pub. Date: Nov. 15, 2018

(54) INTERFACING WITH A COMPUTING DEVICE

(71) Applicant: INTEL CORPORATION, Santa Clara, CA (US)

(72) Inventors: Jiancheng Tao, Shanghai (CN); Xiaoguo Liang, Shanghai (CN); Hong W. Wong, Portland, OR (US); Yanbing Sun, Shanghai (CN); Wah Yiu Kwong, Hillsboro, OR (US)

(73) Assignee: INTEL CORPORATION, Santa Clara, CA (US)

(21) Appl. No.: 15/777,622

(22) PCT Filed: Dec. 26, 2015
(86) PCT No.: PCT/US2015/000367

§ 371 Date: May 18, 2018

(51) Int. Cl. G06F 3/0484; G06F 3/041; G06F 3/01; G06F 3/0488; G06F 3/16

(52) U.S. Cl. CPC G06F 3/04842; G06F 3/0414; G06F 2203/04806; G06F 3/04883; G06F 3/16; G06F 3/017

(57) ABSTRACT

An apparatus for interfacing is described herein. The apparatus includes logic, at least partially including hardware logic, to detect that a blow input received by the apparatus is from a human breath. A characteristic of the blow input is identified. An active application is determined to be running on the apparatus. The blow input is translated to an instruction based on the characteristic and the active application. The instruction is transmitted to the active application.

### TECHNICAL FIELD

This disclosure relates generally to computing devices. Specifically, this disclosure relates to interfacing with a computing device.

### BACKGROUND

Smart devices, such as phones, watches, and tablets, are popular computing devices. These smart devices typically have touchscreens, which provides a useful method for providing input: touch. However, there are various scenarios where a user is not capable of providing a touch input. For example, in addition to the smart device, the user may be carrying something, and not have a free hand to answer a phone. Small devices, like watches, provide other obstacles to touch. On devices with such limited surface area, performing a typical multi-touch operation, e.g., the zoom operation, may not be practical. Other methods for inputting to smart devices, such as gestures, may not be possible if the user's hands are full. Voice commands cannot be used where noise levels are too high for a microphone to reliably recognize voice commands, such as, at a busy airport. Further, in some environments, it may not be practical, or polite, to speak a voice command aloud, such as at a funeral, or other quiet environment.

### BRIEF DESCRIPTION OF THE DRAWINGS

FIG. 1 is a block diagram of a system for interfacing with computing devices;

FIGS. 2A-2B are diagrams of an example computing device receiving blow inputs;

FIGS. 3A-3B are diagrams of an example computing device receiving blow inputs;

FIG. 4 is a diagram of an example computing device receiving a blow input;

FIG. 5 is a diagram of an example computing device for receiving a blow input;

FIG. 6 is a diagram of an example computing device for receiving a blow input;

FIG. 7 is a block diagram of an electronic device for interfacing with blow inputs;

FIG. 8 is a process flow diagram for interfacing with a computing device; and

FIG. 9 is a block diagram showing computer readable media that stores code for interfacing with a computing device.

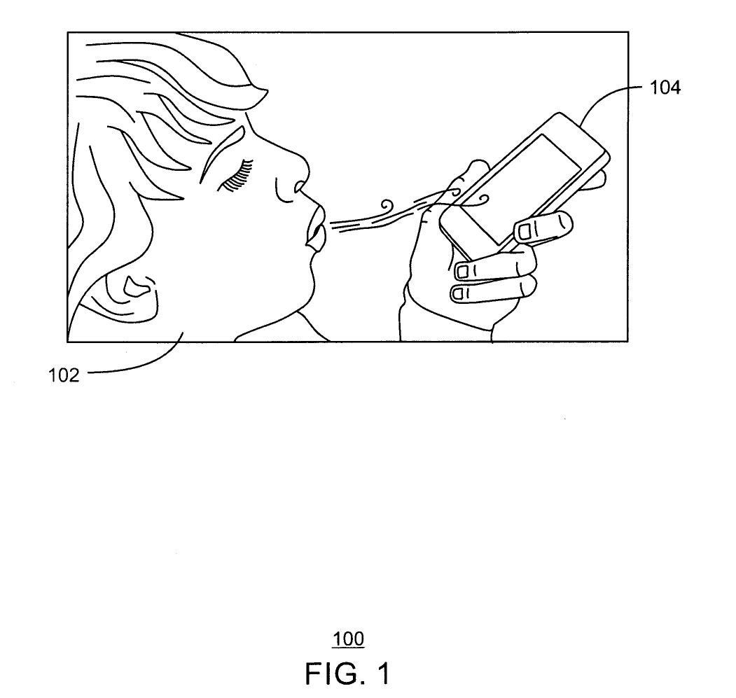

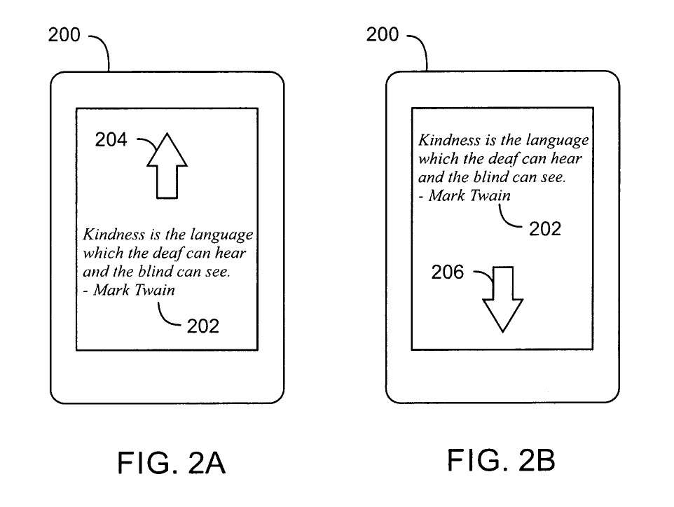

In some cases, the same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In one embodiment of the present techniques, the user may provide inputs by blowing on a computing device. In such an embodiment, the computing device detects a user blowing a breath directed at pressure-sensitive surface, i.e., a blow input. For example, the user may blow on a phone to answer a call, launch an application, or provide any of the numerous potential inputs on a typical computing device with a touch screen.

In the following description, numerous specific details are set forth, such as examples of specific types of processors and system configurations, specific hardware structures, specific architectural and micro architectural details, specific register configurations, specific instruction types, specific system components, specific measurements or heights, specific processor pipeline stages and operation, etc., in order to provide a thorough understanding of the present invention. It will be apparent, however, to one skilled in the art that these specific details need not be employed to practice the present invention. In other instances, well known components or methods, such as specific and alternative processor architectures, specific logic circuits or code for described algorithms, specific firmware code, specific interconnect operation, specific logic configurations, specific manufacturing techniques and materials, specific compiler implementations, specific expression of algorithms in code, specific power down and gating techniques or logic and other specific operational details of computer system have not been described in detail in order to avoid unnecessarily obscuring the present invention.

FIG. 1 is a block diagram of a system 100 for interfacing with a computing device 104. In the system 100, a user 102 provides input by blowing on the computing device 104. Blow inputs are received, and detected, during execution of an active application. The active application can be a user application, or the operating system. User applications are the typical software application run under the authority of a user on the computing device 104. The operating system enables the user to use the user applications and the hardware of the computing device. The computing device 104 may detect a blow input by detecting a pressure change on the surface, and further, be able to determine characteristics of the blow input. Characteristics of the blow input may include the direction of the blow input relative to the center of the screen of the computing device 104, and the duration of the blow input. Based on the characteristics of the blow input, and the currently active application, the computing device 104 may determine a specific user input. Additionally, the blow input may include a number of subsequent blow inputs, wherein a specific number of blow inputs is associated with a specific action for the computing device 104 to take.

As stated previously, the direction of a blow input may be determined based on a direction relative to the center of the device 200. However, the direction of a blown human breath may disperse imperfectly with respect to the center of the device. For example, the user may be travelling by foot, or in a vehicle, and the device 200 may be jarred or otherwise displaced such that, the direction of the blown breath relative to the center of the device 200 changes. In one embodiment of the present techniques, the device 200 may determine the blown direction to be the direction in which a majority of the force of the breath travels. The majority of the force may be determined based on the duration of the breath and the amount of pressure change detected. In other embodiments, a sensitivity to such displacements may be set by the user, or by an application running on the device 200.

FIGS. 2A-2B are diagrams of an example computing device 200 receiving blow inputs. In the FIGS. 2A-2B, the computing device 200 is displaying scrollable text 202. The computing device 200 may display scrollable content, such as text 202, during execution of a reader application, for example. In FIG. 2A, the computing device 200 is receiving a blow input 204 in the upward direction. In this example, a blow input is received in the context of the user viewing scrollable text during execution of the reader application. In response, the computing device 200 may scroll the scrollable text 202 up. In FIG. 2B, the computing device 200 is receiving a blow input 206 in the downward direction. In one embodiment of the present techniques, the computing device 200 may scroll the scrollable text 202 down in response to blow input 206. In some scenarios, the scrollable content may be scrollable in the horizontal and vertical directions. In such embodiments, the content may be scrolled left and right, by blowing in the left and right directions, respectively. It is noted that while the reader application is mentioned as one potential application running on the computing device 200. Any application that displays a scrollable image, text, or other content may perform scrolling using blow inputs. Further, there are numerous other possible responses to a blow input being provided in any application. For example, blow inputs may be used to make screen selections, zoom in and out of the display, enter alphanumeric characters, and so on. The action taken merely depends on how an application, including the operating system, is coded to respond to blow inputs based on their characteristics.

Another characteristic of the blow input is the duration. The duration represents how long the blow input lasts. In one embodiment of the present techniques, the duration of the blow input may be used to determine the action for the computing device to take. For example, a blow input that last longer than a specified threshold, e.g., 1 second, may indicate the computing device is to perform a zoom action.

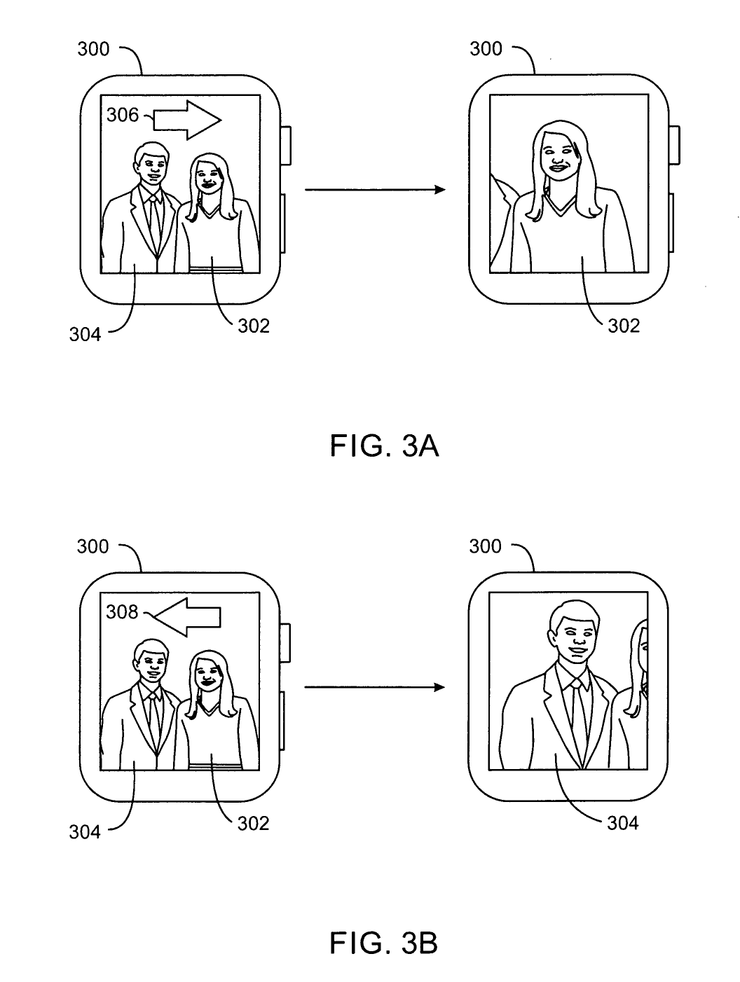

FIGS. 3A-3B are diagrams of an example computing device 300 receiving blow inputs for a zoom action. In FIG. 3A, the computing device 300 is showing an image with two FIGS. 302 and 304, on the left and right sides of the image, respectively. In the left representation, the computing device 300 is receiving a blow input 306 in the right direction. In one embodiment of the present techniques, the computing device may detect that the blow input 306 is occurring at a location, for example, the location of FIG. 304 on the right. If the computing device 300 determines the duration of the blow input is longer than a specific threshold, e.g., 1 second, the computing device 300 may zoom into the right side of the image as shown in the right representation of the computing device 300. The representations of the computing device 200 from left to right indicates a before and after display of the zoom action.

In FIG. 3B, the left representation of the computing device 300 is receiving a blow input 308 in the left direction. Alternatively, the computing device 300 may detect the blow input 308 is occurring at the location of the FIG. 302 on the left side of the image. If the blow input 308 exceeds a duration of 1 second, the computing device may zoom into the left side, as shown in the right side representation of computing device 300. The duration may also be used to specify an amount of zoom. For example, a blow input with a 1-second duration may zoom 25 percent. A blow input with a 2-second duration may zoom 50 percent.

Additionally, in one embodiment of the present techniques, the blow input may be used to make selections on the computing device. For example, using blow inputs, it is possible to perform tasks like answering or refusing a phone call.

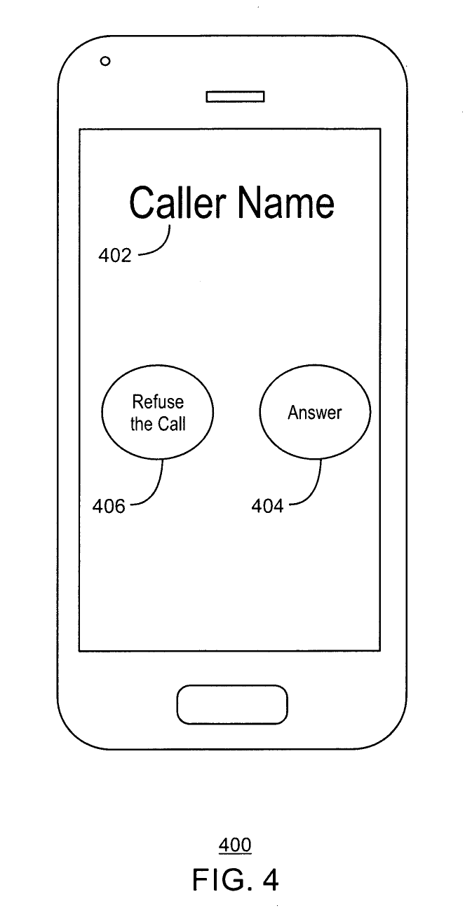

FIG. 4 is a diagram of an example phone 400 preparing to answer or refuse a phone call. Typically, upon receiving a phone call, a computing device, such as the phone 400, ring (or vibrate), and display the caller name 402, and options to answer or refuse the phone call. The phone 400 shows an answer icon 404 and a refuse the call icon 406. In one embodiment of the present techniques, by providing a blow input in the general direction of the selected icon, the user may answer or refuse the call. Specifically, by blowing to the right, the answer icon 404 is selected, and the call is answered. Alternatively, providing a blow input to the left, selects the refuse the call icon 406, and the call is refused, potentially sending the user to a voicemail action. It is noted that the phone call scenario is merely one example of a way to make selections on the computing device using blow inputs. Any application executing on the computing device, including the operating system, may make any of its various selections available to being selected by blow inputs.

One issue that may arise in using blow inputs is the potential for false positive responses to potential blow inputs. For example, the device may mistake a passing wind for the blown breath of a user. In embodiments of the present techniques, the computing device does not take action unless there is an indication that a detected blow input is from a user's breath. In such embodiments, the computing device includes sensors, such as humidity sensors, and thermometers. Using these sensors, the computer device may determine that a detected blow input is a user's breath if there is a difference between the humidity or temperature of the ambient air, and the air detected moving in the detected blow input. Another indication that the detected blow input is a user's breath is that the duration of the blow input lasts for a threshold period of time, such as half a second. Additional sensors may include approximation, location, and infrared sensors to ensure a user is within a specified distance when the blow input is detected. In one embodiment, the computing device may use a camera to ensure that the user is making a blowing gesture when the blow input is detected. In another embodiment, false positives may be avoided by having the user provide a whistling noise after the blow input to ensure the user intended to provide the blow input.

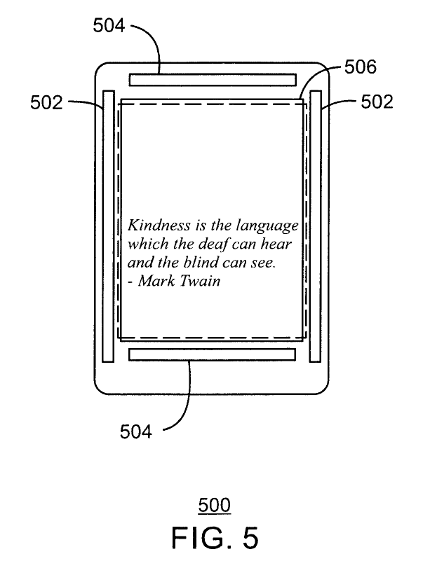

FIG. 5 is a diagram of an example computing device 500 with pressure sensors 502, 504. In one embodiment, the computing device 500 may include pressure sensors 502, 504 at the bezel areas. In an alternative embodiment, force touch sensors may be located at the corners of the computing device. Although the pressure sensors are illustrated as being located at particular positions along the surface of the device, the pressure sensors can also be located above or beneath the display 506. In some cases, the pressure sensors may be integrated with the circuitry of the display 506.

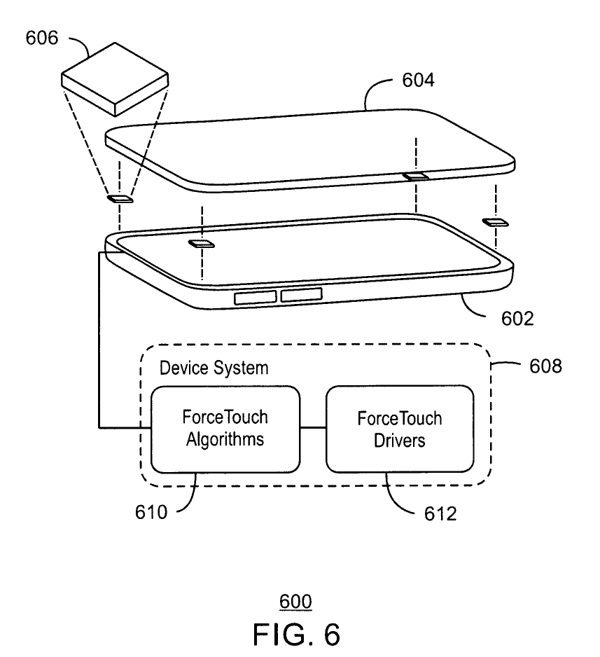

FIG. 6 is a diagram of an example computing device 600 with force touch sensors 606. The example computing device 600 includes a device body 602, a touch surface 604, and the force touch sensors 606. Additionally, the computing device 600 includes a device system 608. The device system 608 includes force touch algorithms 610 and force touch drivers 612. The force touch drivers 612 may detect the blow input, and send a signal indicating the characteristics of the blow input to the force touch algorithms 610. The force touch algorithms 610 algorithms will interpret the touch inputs and request the associated execution of application behavior from computing device 600.

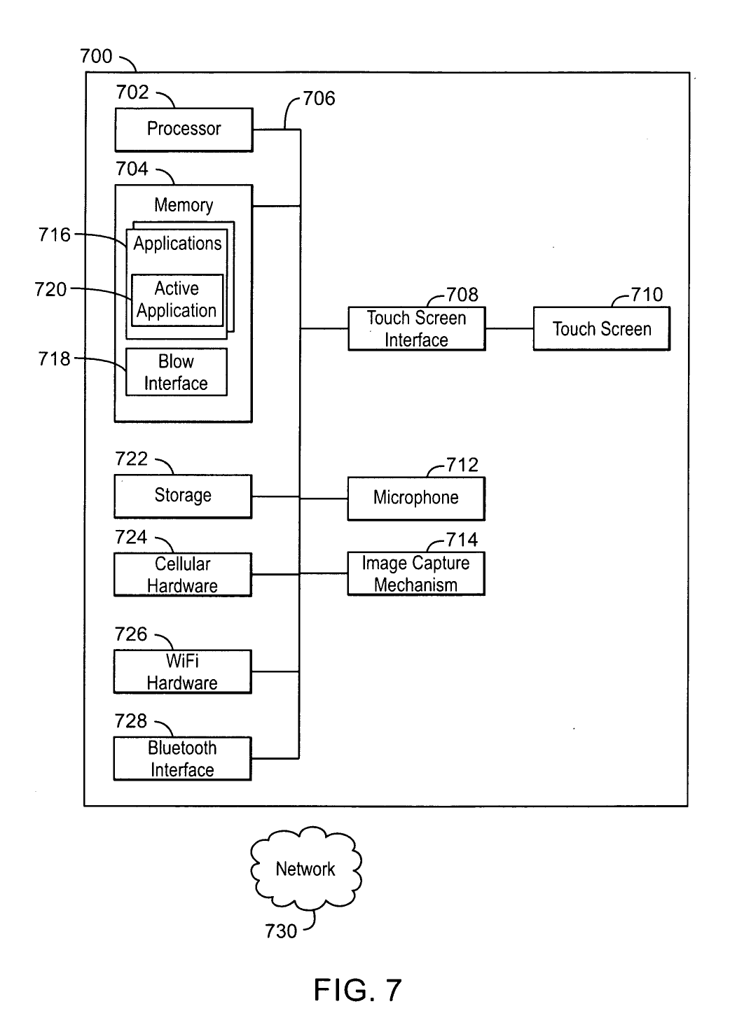

FIG. 7 is a block diagram of an electronic device 700 for interfacing with blow input. The electronic device 700 may be a small form computing device, such as, a tablet computer, mobile phone, smart phone, or wearable device, among others. The electronic device 700 may include a central processing unit (CPU) 702 that is configured to execute stored instructions, as well as a memory device 704 that stores instructions that are executable by the CPU 702. The CPU may be coupled to the memory device 704 by a bus 706. Additionally, the CPU 702 can be a single core processor, a multi-core processor, or any number of other configurations. Furthermore, the electronic device 700 may include more than one CPU 702.

The CPU 702 can be linked through the bus 706 to a touch screen interface 708 configured to connect the electronic device 700 to a touch screen 710. The touch screen 710 may be a built-in component of the electronic device 700 that is sensitive to pressure changes from user touches and blow inputs. Accordingly, the touch screen 710 provides pressure change data in response to touches and blow inputs on the touch screen 710.

Additionally, the electronic device 700 also includes a microphone 712 for capturing sound near the electronic device 700. For example, the microphone 712 may capture a whistle sound the user makes to verify the blow input is not a false positive. The microphone may provide audio data in response to detecting the whistle and other sounds. Further, the electronic device 700 includes an image capture mechanism 714 for capturing image and video. For example, the image capture mechanism 714 may capture an image of the user making a blow input gesture. The image capture mechanism 714 may provide video and image data in response to a user selection to capture image or video.

The memory device 704 may be one of random access memory (RAM), read only memory (ROM), flash memory, or any other suitable memory systems. For example, the memory device 704 may include dynamic random access memory (DRAM). The memory device 704 may include applications 716 and a blow interface 718. The applications 716 may be any of various organizational, educational, and entertainment software applications currently executing on the electronic device 700. The applications 716 include an active application 720, which is the executing application that last received a user input. The blow interface 718 may be an application executing on the electronic device 700 that receives sensor information from the touch screen 710, microphone 712, and image capture mechanism 714. In one embodiment of the present techniques, the blow interface 718 may determine a pressure change has occurred at the touch screen 710. In order to determine the pressure change is a blow input, and not a false positive, the blow interface 718 may trigger the microphone 712 to listen for a whistle confirming the blow input. Additionally, the blow interface 718 may trigger the image capture mechanism 714 to capture an image. The blow interface 718 may thus analyze the image to determine if the image matches that of a user providing a blow input. If the blow input is not a false positive, the blow interface 718 may determine characteristics of the blow input, and provide this blow input information to the active application 720.

The CPU 702 may be linked through the bus 706 to storage device 722. The storage device 722 is a physical memory such as a hard drive, an optical drive, a flash drive, an array of drives, or any combinations thereof. The storage device 722 can store user data, such as audio files, video files, audio/video files, and picture files, among others. The storage device 722 can also store programming code such as device drivers, software applications, operating systems, and the like. The programming code stored to the storage device 722 may be executed by the CPU 702, or any other processors that may be included in the electronic device 700.

The CPU 702 may additionally be linked through the bus 706 to cellular hardware 724. The cellular hardware 724 may be any cellular technology, for example, the 4G standard (International Mobile Telecommunications-Advanced (IMT-Advanced) Standard promulgated by the International Telecommunications Union-Radio communication Sector (ITU-R)). In this manner, the electronic device 700 may access any network 730 without being tethered or paired to another device, where the network 730 includes a cellular network.

The CPU 702 may also be linked through the bus 706 to WiFi hardware 726. The WiFi hardware is hardware according to WiFi standards (standards promulgated as Institute of Electrical and Electronics Engineers' (IEEE) 802.11 standards). The WiFi hardware 726 enables the electronic device 700 to connect to the network 730 using the Transmission Control Protocol and the Internet Protocol (TCP/IP), where the network 730 includes the Internet. Accordingly, the electronic device 700 can enable end-to-end connectivity with the Internet by addressing, routing, transmitting, and receiving data according to the TCP/IP protocol without the use of another device. Additionally, a Bluetooth Interface 728 may be coupled to the CPU 702 through the bus 706. The Bluetooth Interface 728 is an interface according to Bluetooth networks (based on the Bluetooth standard promulgated by the Bluetooth Special Interest Group). The Bluetooth Interface 728 enables the electronic device 700 to be paired with other Bluetooth enabled devices through a personal area network (PAN). Accordingly, the network 730 may include a PAN. Examples of Bluetooth enabled devices include a laptop computer, desktop computer, ultrabook, tablet computer, mobile device, or server, among others.

The block diagram of FIG. 7 is not intended to indicate that the electronic device 700 is to include all of the components shown in FIG. 7. Rather, the electronic device 700 can include fewer or additional components not illustrated in FIG. 7 (e.g., sensors, power management integrated circuits, additional network interfaces, etc.). The electronic device 700 may include any number of additional components not shown in FIG. 7, depending on the details of the specific implementation. Furthermore, any of the functionalities of the CPU 702 may be partially, or entirely, implemented in hardware and/or in a processor. For example, the functionality may be implemented with an application specific integrated circuit, in logic implemented in a processor, in logic implemented in a specialized graphics processing unit, or in any other device.

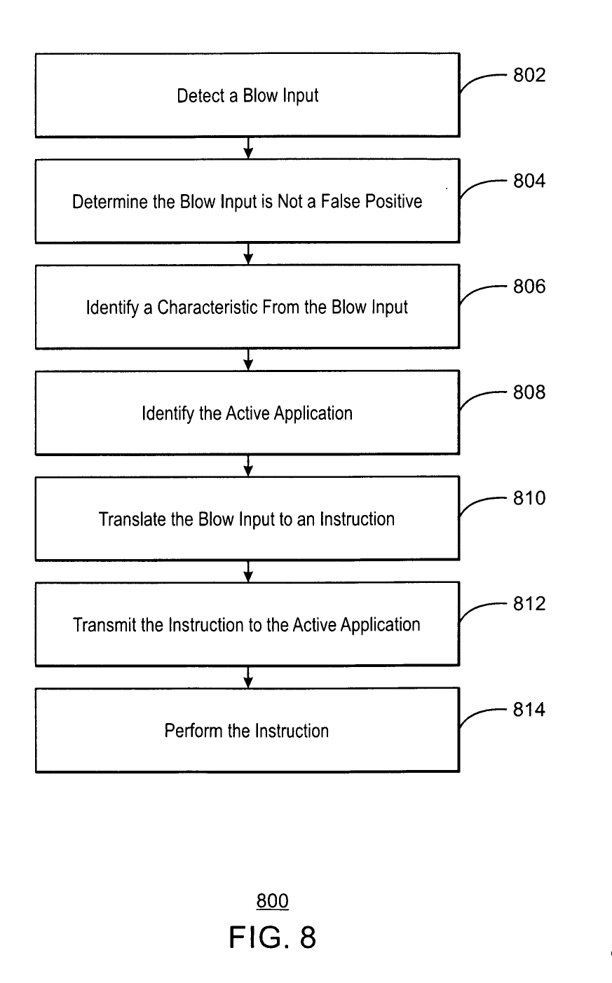

FIG. 8 is a process flow diagram of a method 800 for interfacing with a computing device. The process flow diagram is not intended to represent a sequence of performing the method 800. The method 800 begins at block 802, where the computing device detects a blow input is being provided on the computing device. The computing device may sense an air pressure change with pressure sensors. Alternatively, the computing device may sense the force of a user's breath using force touch sensors.

At block 804, the computing device may determine the detected blow input is not a false positive. The computing device may reject false positives by ensuring the detected blow input is coming from a user's breath. For example, the temperature and the humidity of the detected blow input may be compared to the ambient temperature and humidity. Additionally, sensors may be used to determine if the user is within a specified proximity to the computing device. For example, an image may be captured and analyzed to determine if the image represents that of a user providing a blow input. Further, the user may verify that a detected blow input is intentional by providing an additional signal, e.g., a whistle. Accordingly, the computing device may determine that a detected blow input is not a false positive if whistle is detected after the blow input.

At block 806, the computing device identifies a characteristic of the blow input. The characteristic may be a direction, a duration, or a number of subsequent blows, for example. The direction may be determined by identifying the direction that a majority of the force of the blow input is travelling. The duration of the blow input may be determined to be the amount of time that the blow input is travelling in a consistent direction. A number of subsequent blows may be identified if the sensors detect a number of subsequent pressure changes occurring within a specified time period.

At block 808, the active application running on the apparatus is identified. The active application may be the application that received the most recent user input.

At block 810, the blow input is translated to an instruction based on the characteristic of the blow input and the active application. In one embodiment of the present techniques, the translation may be based on a lookup table containing a translated instruction for each combination of characteristic and active application.

At block 812, the instruction is transmitted to the active application. At block 814, the active application performs the instruction. The instruction may be to scroll scrollable content in the direction of the blow input, to make a selection of an icon being displayed, to zoom in on an image, or any of the myriad of actions possible on a computing device.

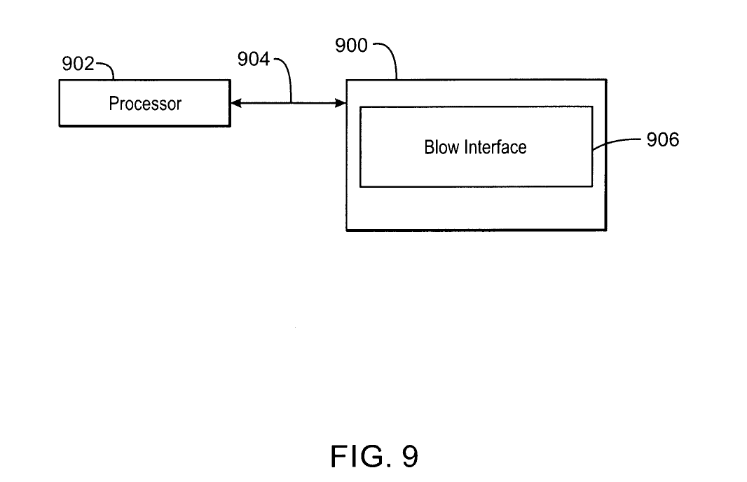

FIG. 9 is a block diagram showing computer readable media 900 that store code for interfacing with a computing device. The computer readable media 900 may be accessed by a processor 902 over a computer bus 904. Furthermore, the computer readable medium 900 may include code configured to direct the processor 902 to perform the methods described herein. In some embodiments, the computer readable media 900 may be non-transitory computer readable media. In some examples, the computer readable media 900 may be storage media. However, in any case, the computer readable media do not include transitory media such as carrier waves, signals, and the like.

The various software components discussed herein can be stored on one or more computer readable media 900, as indicated in FIG. 9. For example, a blow interface 906 can be configured to perform the present techniques described herein. The blow interface 906 detects a blow input received on the apparatus is from a human breath. Additionally, the blow interface 906 determines that the blow input is not a false positive. Further, the blow interface 906 identifies a characteristic of the blow input. The blow interface 906 also identifies an active application running on the apparatus. Additionally, the blow interface 906 translates the blow input to an instruction based on the active application and the characteristic. Further, the blow interface 906 transmits the instruction to the active application.

The block diagram of FIG. 9 is not intended to indicate that the computer readable media 900 is to include all of the components shown in FIG. 9. Further, the computer readable media 900 can include any number of additional components not shown in FIG. 9, depending on the details of the specific implementation.

### EXAMPLES

Example 1 is an apparatus for providing instructions to an active application running on the apparatus. The apparatus includes logic to detect that a blow input received by the apparatus is from a human breath; identify a characteristic of the blow input; identify an active application running on the apparatus; translate the blow input to an instruction based on the characteristic of the blow input and the active application; and transmit the instruction to the active application.

Example 2 includes the apparatus of example 1, including or excluding optional features. In this example, the apparatus includes logic to perform the instruction.

Example 3 includes the apparatus of any one of examples 1 to 2, including or excluding optional features. In this example, the blow input is detected by sensing a pressure change at the touch surface. Optionally, the blow input is detected by: a camera of the apparatus capturing an image; and determining that the image represents a blow input gesture. Optionally, the blow input is detected by determining that a temperature of the blow input is different than an ambient temperature, or determining that a humidity of the blow input is different than an ambient humidity. Optionally, the blow input is detected by: a microphone sensing a sound after the blow input; and determining the sound is a whistle. Optionally, the blow input is detected by: determining that the blow input is in a consistent direction; and determining that a duration of the blow input exceeds a specified threshold.

Example 4 includes the apparatus of example 3, including or excluding optional features. In this example, the characteristic is identified by determining that the blow input occurs for a period of time, wherein the characteristic comprises the duration. Optionally, the duration comprises a time exceeding a threshold, and wherein the instruction comprises an instruction to zoom. Optionally, the instruction comprises an instruction to zoom into a region of an image displayed on a touchscreen of the apparatus, wherein the region is disposed in a direction of the blow input.

Example 5 includes the apparatus of example 4, including or excluding optional features. In this example, the characteristic is identified by detecting a number of subsequent blow inputs, wherein the characteristic comprises the number of subsequent blow inputs, and wherein the instruction is associated with the number.

Example 6 includes the apparatus of example 5, including or excluding optional features. In this example, the characteristic is identified by determining that a majority of the force of the blow input is in a consistent direction, wherein the characteristic comprises the consistent direction.

Example 7 includes the apparatus of any example 6, including or excluding optional features. In this example, the instruction comprises an instruction to select an icon displayed on a touchscreen of the apparatus, wherein the icon is disposed on the touchscreen in a direction of the blow input.

Example 8 includes the apparatus of example 7, including or excluding optional features. In this example, the blow input is translated by performing a lookup of the active application and the characteristic in a lookup table.

Example 9 is a method for providing instructions to an active application running on an apparatus, the method. The method includes detecting that a blow input received by the apparatus is from a human breath; identifying a characteristic of the blow input; identifying an active application running on the apparatus; translating the blow input to an instruction based on the characteristic of the blow input and the active application; and transmitting the instruction to the active application.

Example 10 includes the method of example 9, including or excluding optional features. In this example, the method includes performing the instruction.

Example 11 includes the method of any one of examples 9 to 10, including or excluding optional features. In this example, detecting the blow input comprises sensing a pressure change at the touch surface. Optionally, detecting the blow input comprises: a camera of the apparatus capturing an image; and determining that the image represents a blow input gesture. Optionally, detecting the blow input comprises determining that a temperature of the blow input is different than an ambient temperature, or determining that a humidity of the blow input is different than an ambient humidity. Optionally, detecting the blow input comprises: a microphone sensing a sound after the blow input; and determining the sound is a whistle. Optionally, detecting the blow input comprises: determining that the blow input is in a consistent direction; and determining that a duration of the blow input exceeds a specified threshold.

Example 12 includes the method of example 11, including or excluding optional features. In this example, identifying the characteristic comprises determining that the blow input occurs for a period of time, wherein the characteristic comprises the duration. Optionally, the duration comprises a time exceeding a threshold, and wherein the instruction comprises an instruction to zoom. Optionally, the instruction comprises an instruction to zoom into a region of an image displayed on a touchscreen of the apparatus, wherein the region is disposed in a direction of the blow input.

Example 13 includes the method of example 12, including or excluding optional features. In this example, identifying the characteristic comprises detecting a number of subsequent blow inputs, wherein the characteristic comprises the number of subsequent blow inputs, and wherein the instruction is associated with the number.

Example 14 includes the method of example 13, including or excluding optional features. In this example, identifying the characteristic comprises determining that a majority of the force of the blow input is in a consistent direction, wherein the characteristic comprises the consistent direction.

Example 15 includes the method of example 14, including or excluding optional features. In this example, the instruction comprises an instruction to select an icon displayed on a touchscreen of the apparatus, wherein the icon is disposed on the touchscreen in a direction of the blow input.

Example 16 includes the method of any one of example 15, including or excluding optional features. In this example, translating the blow input comprises performing a lookup of the active application and the characteristic in a lookup table.

Example 17 is at least one computer readable medium for providing instructions to an active application running on an apparatus. The computer-readable medium includes instructions that direct the processor to detect that a blow input received by the apparatus is from a human breath; identify a characteristic of the blow input; identify an active application running on the apparatus; translate the blow input to an instruction based on the characteristic of the blow input and the active application; and transmit the instruction to the active application.

Example 18 includes the computer-readable medium of example 17, including or excluding optional features. In this example, the computer-readable medium includes instructions that cause the apparatus to perform the instruction.

Example 19 includes the computer-readable medium of any one of examples 17 to 18, including or excluding optional features. In this example, the blow input is detected by sensing a pressure change at the touch surface. Optionally, the blow input is detected by: a camera of the apparatus capturing an image; and determining that the image represents a blow input gesture. Optionally, the blow input is detected by determining that a temperature of the blow input is different than an ambient temperature, or determining that a humidity of the blow input is different than an ambient humidity. Optionally, the blow input is detected by: a microphone sensing a sound after the blow input; and determining the sound is a whistle. Optionally, the blow input is detected by: determining that the blow input is in a consistent direction; and determining that a duration of the blow input exceeds a specified threshold.

Example 20 includes the computer-readable medium of example 19, including or excluding optional features. In this example, the characteristic is identified by determining that the blow input occurs for a period of time, wherein the characteristic comprises the duration. Optionally, the duration comprises a time exceeding a threshold, and wherein the instruction comprises an instruction to zoom. Optionally, the instruction comprises an instruction to zoom into a region of an image displayed on a touchscreen of the apparatus, wherein the region is disposed in a direction of the blow input.

Example 21 includes the computer-readable medium of example 20, including or excluding optional features. In this example, the characteristic is identified by detecting a number of subsequent blow inputs, wherein the characteristic comprises the number of subsequent blow inputs, and wherein the instruction is associated with the number.

Example 22 includes the computer-readable medium of example 21, including or excluding optional features. In this example, the characteristic is identified by determining that a majority of the force of the blow input is in a consistent direction, wherein the characteristic comprises the consistent direction.

Example 23 includes the computer-readable medium of any one of example 22, including or excluding optional features. In this example, the instruction comprises an instruction to select an icon displayed on a touchscreen of the apparatus, wherein the icon is disposed on the touchscreen in a direction of the blow input.

Example 24 includes the computer-readable medium of example 23, including or excluding optional features. In this example, the blow input is translated by performing a lookup of the active application and the characteristic in a lookup table.

Example 25 is a system for providing instructions to an active application running on an apparatus. The apparatus includes instructions that direct the processor to means to detect that a blow input received by the apparatus is from a human breath; means to identify a characteristic of the blow input; means to identify an active application running on the apparatus; means to translate the blow input to an instruction based on the characteristic of the blow input and the active application; and means to transmit the instruction to the active application.

Example 26 includes the apparatus of example 25, including or excluding optional features. In this example, the apparatus includes means to perform the instruction.

Example 27 includes the apparatus of any one of examples 25 to 26, including or excluding optional features. In this example, the blow input is detected by sensing a pressure change at the touch surface. Optionally, the blow input is detected by: a camera of the apparatus capturing an image; and determining that the image represents a blow input gesture. Optionally, the blow input is detected by determining that a temperature of the blow input is different than an ambient temperature, or determining that a humidity of the blow input is different than an ambient humidity. Optionally, the blow input is detected by: a microphone sensing a sound after the blow input; and determining the sound is a whistle. Optionally, the blow input is detected by: determining that the blow input is in a consistent direction; and determining that a duration of the blow input exceeds a specified threshold.

Example 28 includes the apparatus of any one of example 27, including or excluding optional features. In this example, the characteristic is identified by determining that the blow input occurs for a period of time, wherein the characteristic comprises the duration. Optionally, the duration comprises a time exceeding a threshold, and wherein the instruction comprises an instruction to zoom. Optionally, the instruction comprises an instruction to zoom into a region of an image displayed on a touchscreen of the apparatus, wherein the region is disposed in a direction of the blow input.

Example 29 includes the apparatus of any one of example 28, including or excluding optional features. In this example, the characteristic is identified by detecting a number of subsequent blow inputs, wherein the characteristic comprises the number of subsequent blow inputs, and wherein the instruction is associated with the number.

Example 30 includes the apparatus of example 29, including or excluding optional features. In this example, the characteristic is identified by determining that a majority of the force of the blow input is in a consistent direction, wherein the characteristic comprises the consistent direction.

Example 31 includes the apparatus of example 30, including or excluding optional features. In this example, the instruction comprises an instruction to select an icon displayed on a touchscreen of the apparatus, wherein the icon is disposed on the touchscreen in a direction of the blow input.

Example 32 includes the apparatus of example 31, including or excluding optional features. In this example, the blow input is translated by performing a lookup of the active application and the characteristic in a lookup table.

Example 33 is a system for providing instructions to an active application running on an apparatus. The apparatus includes instructions that direct the processor to a processor; and a memory comprising instructions that cause the processor to: detect that a blow input received by the apparatus is from a human breath; identify a characteristic of the blow input; identify an active application running on the apparatus; translate the blow input to an instruction based on the characteristic of the blow input and the active application; and transmit the instruction to the active application.

Example 34 includes the apparatus of example 33, including or excluding optional features. In this example, the apparatus includes instructions that cause the processor to perform the instruction.

Example 35 includes the apparatus of any one of examples 33 to 34, including or excluding optional features. In this example, the blow input is detected by sensing a pressure change at the touch surface. Optionally, the blow input is detected by: a camera of the apparatus capturing an image; and determining that the image represents a blow input gesture. Optionally, the blow input is detected by determining that a temperature of the blow input is different than an ambient temperature, or determining that a humidity of the blow input is different than an ambient humidity. Optionally, the blow input is detected by: a microphone sensing a sound after the blow input; and determining the sound is a whistle. Optionally, the blow input is detected by: determining that the blow input is in a consistent direction; and determining that a duration of the blow input exceeds a specified threshold.

Example 36 includes the apparatus of example 35, including or excluding optional features. In this example, the characteristic is identified by determining that the blow input occurs for a period of time, wherein the characteristic comprises the duration. Optionally, the duration comprises a time exceeding a threshold, and wherein the instruction comprises an instruction to zoom. Optionally, the instruction comprises an instruction to zoom into a region of an image displayed on a touchscreen of the apparatus, wherein the region is disposed in a direction of the blow input.

Example 37 includes the apparatus of example 36, including or excluding optional features. In this example, the characteristic is identified by detecting a number of subsequent blow inputs, wherein the characteristic comprises the number of subsequent blow inputs, and wherein the instruction is associated with the number.

Example 38 includes the apparatus of example 37, including or excluding optional features. In this example, the characteristic is identified by determining that a majority of the force of the blow input is in a consistent direction, wherein the characteristic comprises the consistent direction.

Example 39 includes the apparatus of example 38, including or excluding optional features. In this example, the instruction comprises an instruction to select an icon displayed on a touchscreen of the apparatus, wherein the icon is disposed on the touchscreen in a direction of the blow input.

Example 40 includes the apparatus of example 39, including or excluding optional features. In this example, the blow input is translated by performing a lookup of the active application and the characteristic in a lookup table.

Not all components, features, structures, characteristics, etc., described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1-25. (canceled)

26. An apparatus for providing instructions to an active application running on the apparatus, comprising logic, at least partially including hardware logic, to:
detect that a blow input received by the apparatus is from a human breath;
identify a characteristic of the blow input;
identify an active application running on the apparatus;
translate the blow input to an instruction based on the characteristic of the blow input and the active application; and
transmit the instruction to the active application.

27. The apparatus of claim 26, comprising logic to perform the instruction.

28. The apparatus of claim 27, wherein the blow input is detected by sensing a pressure change at the touch surface.

29. The apparatus of claim 28, wherein the blow input is detected by:
a camera of the apparatus capturing an image; and
determining that the image represents a blow input gesture.

30. The apparatus of claim 28, wherein the blow input is detected by determining that a temperature of the blow input is different than an ambient temperature, or determining that a humidity of the blow input is different than an ambient humidity.

31. The apparatus of claim 28, wherein the blow input is detected by:
a microphone sensing a sound after the blow input; and
determining the sound is a whistle.

32. The apparatus of claim 28, wherein the blow input is detected by:
determining that the blow input is in a consistent direction; and
determining that a duration of the blow input exceeds a specified threshold.

33. The apparatus of claim 26, wherein the characteristic is identified by determining that the blow input occurs for a period of time, wherein the characteristic comprises the duration.

34. The apparatus of claim 33, wherein the duration comprises a time exceeding a threshold, and wherein the instruction comprises an instruction to zoom.

35. The apparatus of claim 34, wherein the instruction comprises an instruction to zoom into a region of an image displayed on a touchscreen of the apparatus, wherein the region is disposed in a direction of the blow input.

36. The apparatus of claim 26, wherein the characteristic is identified by detecting a number of subsequent blow inputs, wherein the characteristic comprises the number of subsequent blow inputs, and wherein the instruction is associated with the number.

37. The apparatus of claim 26, wherein the characteristic is identified by determining that a majority of the force of the blow input is in a consistent direction, wherein the characteristic comprises the consistent direction.

38. The apparatus of claim 26, wherein the instruction comprises an instruction to select an icon displayed on a touchscreen of the apparatus, wherein the icon is disposed on the touchscreen in a direction of the blow input.

39. The apparatus of claim 26, wherein the blow input is translated by performing a lookup of the active application and the characteristic in a lookup table.

40. A method for providing instructions to an active application running on an apparatus, the method comprising:
detecting that a blow input received by the apparatus is from a human breath;
identifying a characteristic of the blow input;
identifying an active application running on the apparatus;
translating the blow input to an instruction based on the characteristic of the blow input and the active application; and
transmitting the instruction to the active application.

41. The method of claim 40, comprising performing the instruction.

42. The method of claim 40, wherein detecting the blow input comprises sensing a pressure change at the touch surface.

43. The method of claim 42, wherein detecting the blow input comprises:
a camera of the apparatus capturing an image; and
determining that the image represents a blow input gesture.

44. The method of claim 42, wherein detecting the blow input comprises determining that a temperature of the blow input is different than an ambient temperature, or determining that a humidity of the blow input is different than an ambient humidity.

45. The method of claim 42, wherein detecting the blow input comprises:
a microphone sensing a sound after the blow input; and
determining the sound is a whistle.

46. The method of claim 42, wherein detecting the blow input comprises:
determining that the blow input is in a consistent direction; and
determining that a duration of the blow input exceeds a specified threshold.

47. The method of claim 40, wherein identifying the characteristic comprises determining that the blow input occurs for a period of time, wherein the characteristic comprises the duration.

48. The method of claim 47, wherein the duration comprises a time exceeding a threshold, and wherein the instruction comprises an instruction to zoom.

49. At least one computer readable medium for providing instructions to an active application running on an apparatus, the medium having instructions stored therein that, in response to being executed on the apparatus, cause the apparatus to:
detect that a blow input received by the apparatus is from a human breath;
identify a characteristic of the blow input;
identify an active application running on the apparatus;
translate the blow input to an instruction based on the characteristic of the blow input and the active application; and
transmit the instruction to the active application.

50. The computer readable medium of claim 49, comprising instructions that cause the apparatus to perform the instruction.
